(19) United States
(12) Patent Application Publication
(10) Pub. No.: US 2026/0328950 A1
(43) Pub. Date: Oct. 22, 2026

(54) RESILIENT SATELLITE NAVIGATION PAYLOAD ARCHITECTURE

(71) Applicant: CesiumAstro, Inc., Austin, TX (US)

(72) Inventors: Erik Lier, Phoenixville, PA (US); Thomas Henry Hand, Highlands Ranch, CO (US); Abdul-sattar Kaddoour, Austin, TX (US); Andrew Michael Graff, Austin, TX (US)

(21) Appl. No.: 19/545,117

(22) Filed: Feb. 20, 2026

Related U.S. Application Data
(60) Provisional application No. 63/761,488, filed on Feb. 21, 2025.

(51) Int. Cl. G01S 19/02; H01Q 1/28; H01Q 3/34; H01Q 9/16; H01Q 19/10; H01Q 19/12

(52) U.S. Cl. CPC G01S 19/02; H01Q 1/288; H01Q 3/34; H01Q 9/16; H01Q 19/108; H01Q 19/12

(57) ABSTRACT

The present disclosure provides options for use with global positioning system (GPS) satellite-based navigation payloads. In example embodiments, a navigation payload may include an Earth Coverage (EC) antenna array, a Military Earth Coverage (MEC) antenna array, and a Regional Military Protection (RMP) antenna assembly comprising a phased-array-fed reflector antenna. The payload may be configured to generate navigation signals using a Mission Data Unit synchronized to an atomic clock, transmit Earth coverage navigation signals using the EC antenna array, transmit military navigation signals using the MEC antenna array, and electronically steer one or more high-gain beams using the RMP antenna assembly without mechanical motion. In example embodiments, the payload may selectively apply different radiation patterns to different navigation signal types and may provide detectable navigation signals beyond a terrestrial field of view. Such configurations may support civil users, military users, and space-based users with improved flexibility and resilience.

### CROSS-REFERENCE TO RELATED APPLICATIONS

This application claims the benefit of U.S. Provisional Patent Application No. 63/761,488, filed Feb. 21, 2025, which is incorporated by reference herein in its entirety.

### TECHNICAL FIELD

This disclosure relates generally to satellite payload configurations and, in at least one embodiment, to a resilient navigation payload architecture useful for global positioning system (GPS)-based satellite systems.

### BACKGROUND

A global positioning system (GPS) is a satellite-based navigation system that, like other global navigation satellite systems (GNSS), provides geolocation and timing information to GPS-compatible receivers when sufficiently unobstructed signals are received from multiple GPS satellites, such as at least four satellites. As operational and communications requirements continue to evolve, GPS satellites are expected to support increasingly complex payloads. Future GPS satellites, including both large platforms (for example, GPS IIIF) and smaller platforms (for example, SmallSat architectures), may be required to accommodate Earth Coverage (EC) and Military Earth Coverage (MEC) antennas that provide civil and military navigation signal coverage over a terrestrial Earth field of view from medium Earth orbit (MEO), such as over approximately ±14 degrees. In addition, MEC antennas may be required to provide detectable navigation signals toward higher-altitude regions, including the Military Space Service Volume (MSSV) and cislunar space. GPS satellites may further be required to support Regional Military Protection (RMP) antennas that provide high-power military navigation signals using high-gain spot beams directed toward contested Areas of Intended Effect (AoIE). GPS satellites may also be required to support crosslink payloads, including radio-frequency or optical crosslinks, which may increase constellation autonomy, improve positioning performance, and provide high-data-rate communication paths to and from GPS and other satellite constellations.

There are several challenges associated with providing satellite-based systems capable of supporting these payloads. Such challenges include high manufacturing and launch costs, as well as long lead times required for deploying satellites to achieve a fully operational GPS constellation. Additional challenges arise from limitations of existing antenna technologies. For example, a GPS IIIF RMP reflector antenna may provide a single L1/L2 RMP beam with an approximately 1,800-kilometer ground footprint, while future satellites may be required to radiate two or more simultaneous RMP beams using broadband M-code signals to improve protection against jamming and spoofing, and with smaller footprints, such as approximately 1,200 kilometers, to reduce interference outside the AoIEs. Existing reflector antennas may rely on gimbaled beam steering, which can introduce mechanical jitter that affects beam pointing accuracy, impacts other satellite sensors, and causes satellite drift, resulting in reduced navigation accuracy and degraded autonomous operation. EC antenna arrays may use flat-top isoflux radiation patterns intended for civil coarse acquisition (C/A) code coverage, but such patterns may reduce Effective Isotropic Radiated Power (EIRP) for other EC navigation signals. MEC antenna arrays may transmit dual L1/L2 signals, while some users may require broadband M-code signals, and existing MEC antenna configurations may provide inadequate or non-optimal coverage toward regions such as the MSSV and cislunar space. In addition, helix antenna elements may be used in some navigation antennas, but such elements may be susceptible to multipaction, which increases cost and schedule risk, limits potential future increases in required transmitted power, and requires expensive multipaction testing for each satellite. Helix antenna elements may also support only a single polarization, while future GPS signals may require dual circular polarization, such as for dual-polarization experiments conducted on platforms like NTS-3 in geosynchronous Earth orbit.

### BRIEF DESCRIPTION OF THE DRAWINGS

Various embodiments in accordance with the present disclosure will be described with reference to the drawings, in which:

FIG. 1A illustrates a satellite navigation payload system that may provide Earth coverage, military Earth coverage, and regional military protection functions using a phased-array-fed reflector architecture, according to example embodiments;

FIG. 1B illustrates a satellite navigation payload system that may provide Earth coverage, military Earth coverage, and regional military protection functions using multiple phased-array-fed reflector antennas arranged on opposing sides of a satellite bus, according to example embodiments;

FIG. 1C illustrates a satellite navigation payload system that may provide Earth coverage, military Earth coverage, and regional military protection functions using a phased-array-fed reflector architecture with a passive planar reflect array antenna, according to example embodiments;

FIG. 1D illustrates satellite navigation payload sub-systems that may generate navigation signals for transmission through one or more antennas, according to example embodiments;

FIG. 1E illustrates an example signal generation and modulation process that may be performed by a Mission Data Unit to produce a transmitted satellite navigation signal, according to example embodiments;

FIG. 2 illustrates a transmit-only phased-array-fed reflector Active Electronically Steered Array feed that may be used to generate electronically steerable high-gain beams, according to example embodiments;

FIG. 3A illustrates a transmit-only antenna feed architecture that may distribute broadband navigation signals to an antenna array with substantially uniform amplitude and phase, according to example embodiments;

FIG. 3B illustrates a Military Earth Coverage antenna feed and array configuration that may radiate broadband military navigation signals toward the Earth and beyond an Earth field of view, according to example embodiments;

FIG. 4 illustrates an example operational geometry showing how military navigation signals radiated from a Military Earth Coverage antenna array may provide coverage toward higher-altitude regions including a Military Space Service Volume and cislunar space, according to example embodiments;

FIG. 5 illustrates a baseline Earth Coverage antenna array configuration in which an isoflux radiation pattern may be applied to all navigation codes, according to example embodiments;

FIG. 6 illustrates an optional Earth Coverage antenna array configuration in which an isoflux radiation pattern may be applied to a civil coarse acquisition code only while other navigation codes may be radiated with higher average EIRP, according to example embodiments;

FIG. 7A illustrates a magneto-electric dipole antenna with dipole elements, according to example embodiments;

FIG. 7B illustrates a plurality of magneto-electric dipole array elements arranged in a two-dimensional array along orthogonal axes, according to example embodiments; and

FIG. 8 illustrates a process for steering a beam, according to example embodiments.

### DETAILED DESCRIPTION

Approaches in accordance with various embodiments may provide a navigation payload configuration for satellite-based GPS systems. Such payloads may support the Resilient Global Positioning System (R-GPS) Request for Prototype Proposal (RPP), Project No. {24-05}. In at least one embodiment, the navigation payload may include an Earth Coverage (EC) antenna configured to transmit L1/L2 P(Y) codes and a civil coarse acquisition (C/A) L1 code, a Military Earth Coverage (MEC) antenna configured to transmit military M-code signals, and a multibeam Regional Military Protection (RMP) high-gain antenna configured to transmit M-code signals toward selected Areas of Intended Effect (AoIE).

The GPS II and GPS III satellites currently form the backbone of the GPS Government Reference Architecture (GRA). A primary objective of adding a complementary and proliferated constellation of smaller R-GPS satellites to the GRA is to enhance system resilience and operational capabilities, including warfighter capabilities. Navigation payloads in accordance with various embodiments may provide capability and performance improvements compared to prior payload solutions, such as the GPS III payload, as described below.

With respect to the RMP antenna configuration, GPS III satellites (SV11 and forward) provide a single RMP beam. In contrast, embodiments disclosed herein may support multiple simultaneous and independent beams, such as two to four beams. GPS III transmits dual military L1/L2 signals, whereas disclosed embodiments may transmit broadband M-code signals to improve resistance to jamming and spoofing. In example embodiments, the RMP antenna may provide an approximately 1,200-kilometer ground footprint using a reflector having a diameter of about 3.5 meters, which may reduce interference outside the AoIE, compared to the approximately 1,800-kilometer footprint provided by a 2.3-meter reflector on GPS III. GPS III also uses gimbaled beam steering, which may introduce mechanical jitter that affects beam pointing accuracy, causes satellite drift, and degrades navigation accuracy and autonomous operation. Disclosed embodiments may instead use electronic beam steering without mechanical motion. In addition, GPS III uses a parabolic reflector surface, while disclosed embodiments may use a near-spherical and/or approximately spherical reflector surface that may provide improved scan performance. With respect to the MEC antenna configuration, GPS III satellites transmit dual military L1/L2 signals. Disclosed embodiments may instead transmit broadband M-code signals to enhance anti-jam and anti-spoof performance. GPS III provides limited and non-optimal coverage toward the Military Space Service Volume (MSSV) and cislunar regions. In contrast, disclosed embodiments may provide detectable navigation signals over nearly the entire field of view beyond the Earth shadow, such as from approximately ±14 degrees to ±90 degrees.

With respect to the EC antenna configuration, GPS III radiates all EC signals, including L1 and L2 P(Y) and other codes, using a flat-top isoflux radiation pattern intended primarily to satisfy C/A code requirements. This approach may reduce the average EIRP for other EC navigation signals. In contrast, disclosed embodiments may radiate only the C/A code using a flat-top isoflux pattern, while radiating other navigation codes using a more efficient radiation pattern, thereby increasing the average transmitted power of the other codes by more than 2 dB over the Earth field of view.

With respect to power amplifier technology, GPS III satellites use travelling wave tube amplifiers (TWTAs) to generate high transmit power for EC and MEC antennas on GPS IIIA satellites and for the RMP antenna on GPS IIIF satellites. In contrast, embodiments disclosed herein may use solid-state power amplifiers (SSPAs), which may reduce cost.

With respect to antenna element design, GPS III navigation antennas use tapered helix radiating elements, such as four-helix RMP feed array, four-helix MEC array, and twelve-helix EC array. These helix elements are susceptible to multipaction, which increases cost and schedule risk, limits potential increases in future required transmitted power, and requires expensive multipaction testing for each space vehicle. Disclosed embodiments may instead use low-profile magneto-electric (ME) dipole antenna elements that can tolerate significantly higher RF power before multipaction occurs, thereby eliminating the need for multipaction testing for each satellite. In addition, GPS III navigation antennas support only a single polarization, whereas disclosed embodiments may support dual right-hand circular polarization (RHCP) and left-hand circular polarization (LHCP), which may be required for future GPS signals, including dual-polarization experiments such as those conducted on NTS-3 in geosynchronous Earth orbit.

The present disclosure describes a GPS satellite navigation payload architecture that integrates a multi-beam, electronically steerable RMP antenna with improved EC and MEC antenna configurations. The payload includes a phased-array-fed reflector or reflect array RMP antenna in which an active phased-array feed illuminates a passive reflector surface, enabling the formation of multiple independent, high-gain beams that can be steered electronically without mechanical gimbals. This allows simultaneous protection of multiple regions and avoids jitter associated with mechanical steering. The disclosure further provides EC and MEC arrays located on an Earth-facing deck, with the EC array configured so that an isoflux radiation pattern is applied only to the civil L1 C/A code, while other navigation codes are radiated with more efficient patterns with higher average signal power over the Earth. The MEC array is configured to transmit broadband military signals with improved radiation toward regions beyond the Earth field of view. Together, these features provide a more resilient and power-efficient navigation payload compared to conventional GPS satellite payload architectures.

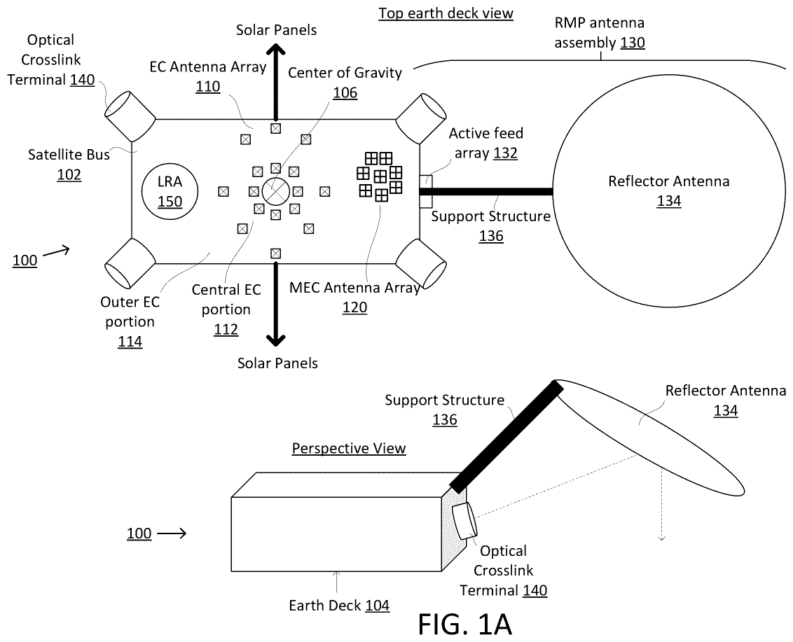

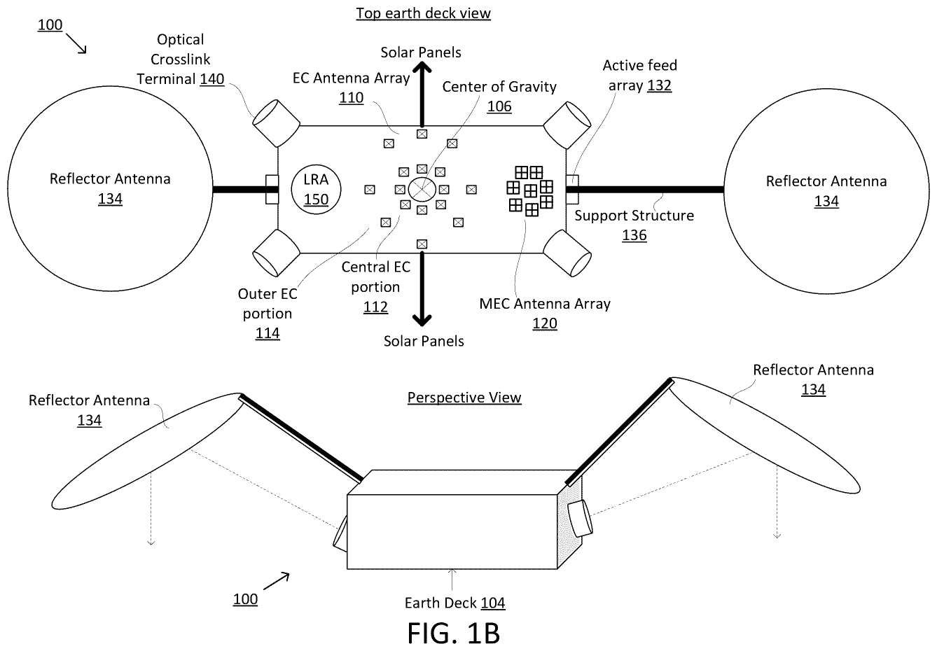

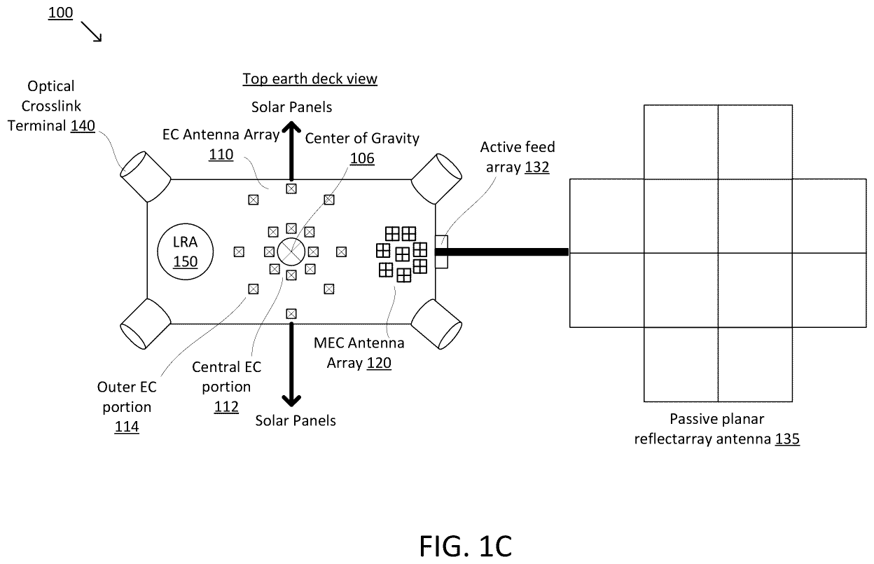

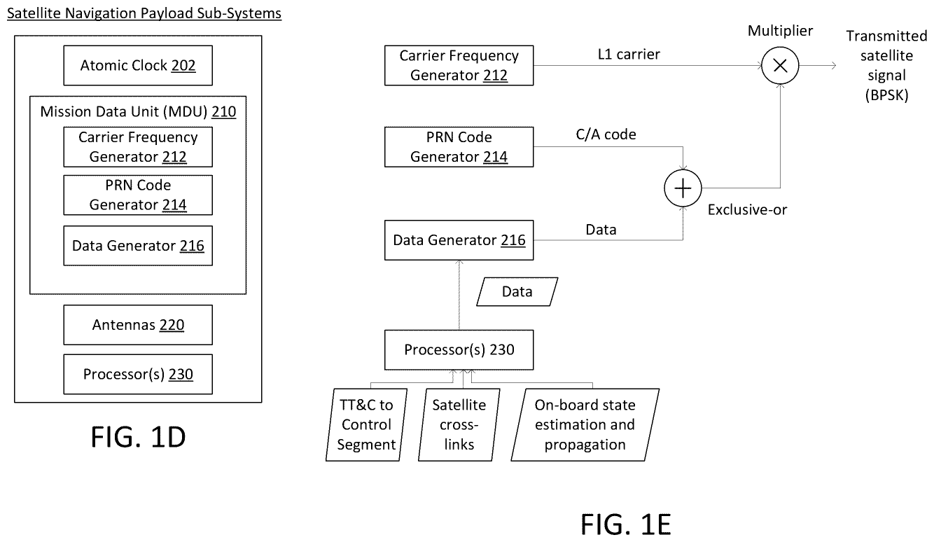

FIG. 1A illustrates a satellite navigation payload system 100 for providing Earth coverage navigation signals, military Earth coverage navigation signals, and regional military protection navigation signals using a phased-array-fed reflector architecture in example embodiments. The satellite navigation payload system 100 may be mounted on a satellite bus 102 that may include an Earth deck 104 and a center of gravity 106. In example embodiments, the Earth deck 104 may support multiple navigation payload components while the satellite bus 102 may provide structural, thermal, and electrical interfaces for operation in orbit, including solar panels for the generation of power for the navigation payload.

In example embodiments, the satellite navigation payload system 100 may include an Earth Coverage (EC) antenna array 110, a Military Earth Coverage (MEC) antenna array 120, and a Regional Military Protection (RMP) antenna assembly 130. The EC antenna array 110 and the MEC antenna array 120 may be located on the Earth deck 104 and may be oriented to radiate navigation signals toward the Earth. The RMP antenna assembly 130 may be deployed away from the satellite bus 102 to provide high-gain directional coverage. In example embodiments, the satellite navigation payload system 100 may further include an optical crosslink terminal 140 and a laser retroreflector array (LRA) 150, each of which may be mounted on the Earth deck 104 or other surfaces of the satellite bus 102.

In example embodiments, the EC antenna array 110 may include a central EC portion 112 and an outer EC portion 114 arranged around the central EC portion 112. The central EC portion is located above the center of gravity of the satellite. The outer EC portion 114 may be configured to radiate an isoflux radiation pattern for a civil coarse acquisition (C/A) code signal, while the central EC portion 112 may be configured to radiate other navigation signals using a different radiation pattern. In example embodiments, this configuration may increase an average radiated power for non-C/A navigation signals over an Earth field of view while maintaining required signal coverage. As a nonlimiting example, the EC antenna array 110 may apply an isoflux radiation pattern only to an L1 C/A code while encrypted or military navigation signals may be radiated with higher average gain toward terrestrial users. In example embodiments, the EC antenna array 110 may be sized to fit within a footprint of approximately one meter on the Earth deck 104, although other sizes and configurations may be used in other example embodiments.

In example embodiments, the MEC antenna array 120 may include a plurality of antenna elements arranged to provide substantially uniform amplitude and phase distribution.

The MEC antenna array 120 may be configured to radiate broadband military navigation signals toward the Earth and beyond an Earth field of view, including toward higher-altitude users beyond the Earth shadow.

In example embodiments, the RMP antenna assembly 130 may include an active feed array 132 coupled to a reflector antenna 134 to form a phased-array-fed reflector (PAFR) antenna. The active feed array 132 may include a plurality of radiating elements and associated phase and amplitude control circuitry that may generate multiple independent feed excitations.

The reflector antenna 134 may reflect energy from the active feed array 132 to form one or more high-gain spot beams. In example embodiments, the active feed array 132 may electronically steer the one or more spot beams without mechanical motion of the reflector antenna 134.

In example embodiments, the reflector antenna 134 may be mechanically supported relative to the satellite bus 102 by a support structure 136 that is stowed during launch and deployed in orbit. The support structure 136 may position the reflector antenna 134 away from the Earth deck 104 to reduce blockage and interference. In example embodiments, the support structure 136 may include a fixed mount or a motorized interface that may provide coarse pointing or stowage capability, while fine beam steering may be performed electronically by the active feed array 132.

As a nonlimiting example, during on-orbit operation, the satellite navigation payload system 100 may use the EC antenna array 110 to broadcast civil and some military navigation signals globally, the MEC antenna array 120 to transmit broadband military navigation signals toward the Earth and higher-altitude users, and the RMP antenna assembly 130 to electronically form and steer multiple high-gain military navigation signal beams toward contested geographic regions. In example embodiments, the optical crosslink terminal 140 may exchange data with other satellites to support constellation-level coordination, while the laser retroreflector array 150 may enable precise ranging measurements from ground-based stations. Other example embodiments may use different antenna sizes, reflector shapes, feed configurations, payload layouts, or operational sequences while remaining within the scope of the disclosure.

FIG. 1B illustrates a satellite navigation payload system 100 that may provide Earth coverage navigation signals, military Earth coverage navigation signals, and regional military protection navigation signals using multiple phased-array-fed reflector antennas in example embodiments. The satellite navigation payload system 100 may be mounted on a satellite bus 102 that may include an Earth deck 104 and a center of gravity 106. In example embodiments, the Earth deck 104 may support multiple navigation payload components while the satellite bus 102 may provide mechanical, electrical, and thermal interfaces for operation in a space environment.

In example embodiments, the satellite navigation payload system 100 may include an Earth Coverage (EC) antenna array 110, a Military Earth Coverage (MEC) antenna array 120, and a Regional Military Protection (RMP) antenna assembly 130. The EC antenna array 110 and the MEC antenna array 120 may be mounted on the Earth deck 104 and may be oriented to radiate navigation signals toward the Earth. The EC antenna array 110 which is mounted above the satellite center of gravity may include a central EC portion 112 and an outer EC portion 114, where the combined center and outer EC portions may radiate an isoflux radiation pattern for a civil coarse acquisition (C/A) code signal and the central EC portion 112 may radiate other navigation signals using a different radiation pattern. In example embodiments, this configuration may increase an average radiated power for non-C/A navigation signals over an Earth field of view while maintaining the required signal coverage for other codes. In example embodiments, the EC antenna array 110 may be sized to fit within a defined footprint on the Earth deck 104, although other sizes, element counts, and layouts may be used in other example embodiments.

In example embodiments, the MEC antenna array 120 may include a plurality of antenna elements arranged to provide substantially uniform amplitude and phase distribution. The MEC antenna array 120 may be configured to radiate broadband military navigation signals toward the Earth and beyond an Earth field of view, including toward higher-altitude users.

In example embodiments, the RMP antenna assembly 130 may include a plurality of reflector antennas 134 arranged on opposing sides of the satellite bus 102. Each reflector antenna 134 may be coupled to a corresponding active feed array 132 to form a phased-array-fed reflector antenna. The active feed array 132 may include a plurality of radiating elements and associated phase and amplitude control circuitry that may generate one or more feed excitations. Each reflector antenna 134 may reflect energy from the corresponding active feed array 132 to form one or more high-gain spot beams. In example embodiments, the active feed arrays 132 may electronically steer the one or more spot beams without mechanical motion of the reflector antennas 134.

In example embodiments, each reflector antenna 134 may be mechanically supported relative to the satellite bus 102 by a support structure 136. The support structures 136 may position the reflector antennas 134 away from the Earth deck 104 to reduce blockage and interference and to provide balanced mechanical loading on the satellite bus 102. In example embodiments, the support structures 136 may include fixed mounts or motorized interfaces that may provide coarse pointing or stowage capability, while fine beam steering may be performed electronically by the active feed arrays 132.

In example embodiments, the satellite navigation payload system 100 may further include an optical crosslink terminal 140 and a laser retroreflector array (LRA) 150 mounted on the Earth deck 104 or other surfaces of the satellite bus 102. The optical crosslink terminal 140 may enable inter-satellite communications, while the laser retroreflector array 150 may support precision ranging from ground-based stations.

As a nonlimiting example, during on-orbit operation, the satellite navigation payload system 100 illustrated in FIG. 1B may use the EC antenna array 110 to broadcast civil navigation signals globally, the MEC antenna array 120 to transmit broadband military navigation signals toward the Earth and higher-altitude users, and the reflector antennas 134 of the RMP antenna assembly 130 to electronically form and steer high-gain beams toward different geographic areas of intended effect on opposite sides of the satellite bus 102. In example embodiments, this configuration may provide symmetric beam coverage and reduced disturbance torques, while other example embodiments may use different numbers of reflector antennas, reflector sizes, feed configurations, or payload layouts to achieve similar navigation and protection functions.

FIG. 1C illustrates a satellite navigation payload system 100 that may provide Earth coverage navigation signals, military Earth coverage navigation signals, and regional military protection navigation signals using a phased-array-fed reflector architecture with a passive planar reflectarray in example embodiments. The satellite navigation payload system 100 may be mounted on a satellite bus 102 that may include an Earth deck 104 and a center of gravity 106. In example embodiments, the Earth deck 104 may support multiple navigation payload components while the satellite bus 102 may provide structural, electrical, and thermal interfaces for operation in orbit, including solar panels that generate power for all active components onboard the satellite.

In example embodiments, the satellite navigation payload system 100 may include an Earth Coverage (EC) antenna array 110, a Military Earth Coverage (MEC) antenna array 120, and a Regional Military Protection (RMP) antenna assembly 130. The EC antenna array 110 and the MEC antenna array 120 may be mounted on the Earth deck 104 and may be oriented to radiate navigation signals toward the Earth. The EC antenna array 110 may include a central EC portion 112 and an outer EC portion 114, where the combined central and outer EC portions may be configured to radiate an isoflux radiation pattern for a civil coarse acquisition (C/A) code signal, and the central EC portion 112 may be configured to radiate other navigation signals providing a different radiation pattern. In example embodiments, this configuration may increase an average radiated power for non-C/A navigation signals over an Earth field of view while maintaining the required coverage for other signals. In example embodiments, the EC antenna array 110 may be sized to fit within a defined footprint on the Earth deck 104, although other array sizes, element counts, and layouts may be used in other example embodiments.

In example embodiments, the MEC antenna array 120 may include a plurality of antenna elements arranged to provide substantially uniform amplitude and phase distribution. The MEC antenna array 120 may be configured to radiate broadband military navigation signals toward the Earth and beyond an Earth field of view, including toward higher-altitude users. In example embodiments, the RMP antenna assembly 130 may include an active feed array 132 coupled to a passive planar reflectarray antenna 135 to form a phased-array-fed reflector antenna. The active feed array 132 may include a plurality of radiating elements and associated phase and amplitude control circuitry that may generate one or more feed excitations. The passive planar reflectarray antenna 135 may include a plurality of radiating elements arranged over a planar surface, where the radiating elements may be configured to reflect incident energy from the active feed array 132 with controlled phase shifts to form one or more high-gain spot beams. In example embodiments, beam steering may be achieved electronically through control of the active feed array 132 and the passive planar reflectarray antenna 135, without mechanical motion of the passive planar reflectarray antenna 135.

In example embodiments, the passive planar reflectarray antenna 135 may be mechanically supported relative to the satellite bus 102 by a support structure 136. The support structure 136 may position the passive planar reflectarray antenna 135 away from the Earth deck 104 to reduce blockage and interference. In example embodiments, the support structure 136 may include a fixed mount or a deployable interface that may provide stowage and deployment capability, while fine beam steering may be performed electronically by the active feed array 132.

In example embodiments, the satellite navigation payload system 100 may further include an optical crosslink terminal 140 and a laser retroreflector array (LRA) 150 mounted on the Earth deck 104 or other surfaces of the satellite bus 102. The optical crosslink terminal 140 may enable inter-satellite communications, while the laser retroreflector array 150 may support precision ranging measurements from ground-based stations.

As a nonlimiting example, during on-orbit operation, the satellite navigation payload system 100 illustrated in FIG. 1C may use the EC antenna array 110 to broadcast civil navigation signals globally, the MEC antenna array 120 to transmit broadband military navigation signals toward the Earth and higher-altitude users, and the RMP antenna assembly 130 including the passive planar reflectarray antenna 135 to electronically form and steer one or more high-gain beams toward geographic areas of intended effect. In example embodiments, other reflectarray sizes, feed configurations, element layouts, or deployment mechanisms may be used to achieve similar navigation and protection functions while remaining within the scope of the disclosure.

FIG. 1C illustrates a satellite navigation payload system 100 that may provide Earth coverage navigation signals, military Earth coverage navigation signals, and regional military protection navigation signals using a phased-array-fed reflector architecture with a passive planar reflectarray in example embodiments. The satellite navigation payload system 100 may be mounted on a satellite bus 102 that may include an Earth deck 104 and a center of gravity 106. In example embodiments, the Earth deck 104 may support multiple navigation payload components while the satellite bus 102 may provide structural, electrical, and thermal interfaces for operation in orbit.

In example embodiments, the satellite navigation payload system 100 may include an Earth Coverage (EC) antenna array 110, a Military Earth Coverage (MEC) antenna array 120, and a Regional Military Protection (RMP) antenna assembly 130. The EC antenna array 110 and the MEC antenna array 120 may be mounted on the Earth deck 104 and may be oriented to radiate navigation signals toward the Earth. The EC antenna array 110 may include a central EC portion 112 and an outer EC portion 114, where the combined central and outer EC portions 112 and 114 may be configured to radiate an isoflux radiation pattern for a civil coarse acquisition (C/A) code signal and the central EC portion 112 may be configured to radiate other navigation signals using a different radiation pattern. In example embodiments, this configuration may increase an average radiated power for non-C/A navigation signals over an Earth field of view while maintaining required signal coverage for other codes. In example embodiments, the EC antenna array 110 may be sized to fit within a defined footprint on the Earth deck 104, although other array sizes, element counts, and layouts may be used in other example embodiments.

In example embodiments, the MEC antenna array 120 may include a plurality of antenna elements arranged to provide substantially uniform amplitude and phase distribution.

The MEC antenna array 120 may be configured to radiate broadband military navigation signals toward the Earth and beyond an Earth field of view, including toward higher-altitude users. In example embodiments, the RMP antenna assembly 130 may include an active feed array 132 coupled to a passive planar reflectarray antenna 135 to form a phased-array-fed reflector antenna. The active feed array 132 may include a plurality of radiating elements and associated phase and amplitude control circuitry that may generate one or more feed excitations. The passive planar reflectarray antenna 135 may include a plurality of radiating elements arranged over a planar surface, where the radiating elements may be configured to reflect incident energy from the active feed array 132 with controlled phase shifts to form one or more high-gain spot beams. In example embodiments, beam steering may be achieved electronically through control of the active feed array 132 and the passive planar reflectarray antenna 135, without mechanical motion of the passive planar reflectarray antenna 135.

In example embodiments, the passive planar reflectarray antenna 135 may be mechanically supported relative to the satellite bus 102 by a support structure 136. The support structure 136 may position the passive planar reflectarray antenna 135 away from the Earth deck 104 to reduce blockage and interference. In example embodiments, the support structure 136 may include a fixed mount or a deployable interface that may provide stowage and deployment capability, while fine beam steering may be performed electronically by the active feed array 132.

In example embodiments, the satellite navigation payload system 100 may further include an optical crosslink terminal 140 and a laser retroreflector array (LRA) 150 mounted on the Earth deck 104 or other surfaces of the satellite bus 102. The optical crosslink terminal 140 may enable inter-satellite communications, while the laser retroreflector array 150 may support precision ranging measurements from ground-based stations.

As a nonlimiting example, during on-orbit operation, the satellite navigation payload system 100 illustrated in FIG. 1C may use the EC antenna array 110 to broadcast civil navigation signals globally, the MEC antenna array 120 to transmit broadband military navigation signals toward the Earth and higher-altitude users, and the RMP antenna assembly 130 including the passive planar reflectarray antenna 135 to electronically form and steer one or more high-gain beams toward geographic areas of intended effect. In example embodiments, other reflectarray sizes, feed configurations, element layouts, or deployment mechanisms may be used to achieve similar navigation and protection functions while remaining within the scope of the disclosure.

FIG. 1D illustrates satellite navigation payload sub-systems that may be used by a satellite navigation payload system 100 to generate navigation signals in example embodiments. In example embodiments, the satellite navigation payload sub-systems may include an atomic clock 202, a Mission Data Unit (MDU) 210, one or more antennas 220, and one or more processors 230. The atomic clock 202 may provide a highly stable timing reference that may be used by the MDU 210 to support precise carrier generation and code timing. The one or more processors 230 may control operation of the MDU 210, manage signal generation parameters, and coordinate transmission of navigation signals through the one or more antennas 220.

In example embodiments, the MDU 210 may include a carrier frequency generator 212, a pseudorandom noise (PRN) code generator 214, and a data generator 216. The carrier frequency generator 212 may generate one or more radio-frequency carrier signals, such as L-band carrier signals, based at least in part on timing information derived from the atomic clock 202. The PRN code generator 214 may generate one or more ranging codes, such as a civil coarse acquisition (C/A) code or encrypted military codes. The data generator 216 may generate navigation data, telemetry data, or other information that may be combined with the PRN codes prior to modulation onto a carrier signal. The sources of the data provided by the one or more processors 230 to the data generator 216 may include a telemetry, tracking, and control communications link to a control segment, satellite cross-links, or an on-board state estimator and propagator.

As a nonlimiting example, during on-orbit operation, the atomic clock 202 may provide timing signals to the MDU 210, the carrier frequency generator 212 may generate an L1 carrier signal, the PRN code generator 214 may generate a C/A code sequence, and the data generator 216 may generate navigation message data. The one or more processors 230 may coordinate these operations such that the combined signal may be transmitted through the one or more antennas 220 toward terrestrial or space-based receivers. In example embodiments, other signal generators, timing sources, or processing architectures may be used while remaining within the scope of the disclosure.

FIG. 1E illustrates an example signal generation and modulation process that may be performed by a satellite navigation payload system using a Mission Data Unit in example embodiments. In example embodiments, the process illustrated in FIG. 1E may generate a transmitted satellite navigation signal by combining carrier signals, ranging codes, and navigation data prior to transmission through one or more antennas. The elements illustrated in FIG. 1E may be implemented as hardware, software, or a combination thereof, and other example embodiments not explicitly shown may additionally or alternatively be used.

In example embodiments, a carrier frequency generator 212 may generate an L-band carrier signal, such as an LI carrier, using timing information derived from an atomic clock. A pseudorandom noise (PRN) code generator 214 may generate a ranging code, such as a civil coarse acquisition (C/A) code. A data generator 216 may generate navigation data that may include ephemeris data, clock correction data, health data, or other navigation message content. In example embodiments, the navigation data generated by the data generator 216 may be combined with the C/A code generated by the PRN code generator 214 using an exclusive-or operation to produce a composite spreading sequence.

In example embodiments, the composite spreading sequence may be provided to a multiplier, where the composite spreading sequence may be multiplied with the carrier signal generated by the carrier frequency generator 212 to produce a transmitted satellite signal, such as a binary phase-shift keyed (BPSK) signal. The transmitted satellite signal may then be routed to downstream radio-frequency components and transmitted through one or more antennas toward terrestrial or space-based receivers. Other modulation formats or carrier frequencies may, in other example embodiments, additionally or alternatively be used.

In example embodiments, one or more processors 230 may control operation of the data generator 216, the PRN code generator 214, and the carrier frequency generator 212. The one or more processors 230 may receive input data from a telemetry, tracking, and control (TT&C) interface coupled to a control segment, from one or more satellite cross-links, and from an on-board state estimation and propagation module. In example embodiments, the TT&C interface may provide command and control data from a ground-based control segment, the satellite cross-links may provide navigation or timing information received from other satellites in a constellation, and the on-board state estimation and propagation module may provide predicted satellite state information generated using on-board models and sensor inputs.

As a nonlimiting example, during on-orbit operation, the one or more processors 230 may receive updated ephemeris or clock correction data via the TT&C interface from the control segment, receive supplemental timing or navigation information via satellite cross-links from neighboring satellites, and receive predicted state information from the on-board state estimation and propagation module. The one or more processors 230 may then cause the data generator 216 to generate updated navigation message data based on the received information, which may be combined with the C/A code and modulated onto the carrier signal to produce the transmitted satellite signal illustrated in FIG. 1E.

In example embodiments, the actions illustrated in FIG. 1E may be performed continuously during satellite operation, while in other example embodiments, the actions may be performed intermittently, in a different order, or using additional or alternative signal generation components. Other example embodiments may support additional navigation signals, encrypted military signals, or alternative data sources while remaining within the scope of the present disclosure.

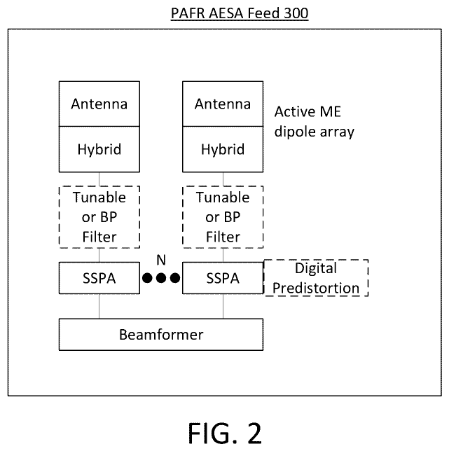

FIG. 2 illustrates example Regional Military Protection (RMP) phased-array-fed reflector (PAFR) Active Electronically Steered Array (AESA) feed 300 architectures that may be used with the RMP antenna assembly 130 in example embodiments. In example embodiments, the AESA feed architectures illustrated in FIG. 2 may be implemented as active feed arrays 132 configured to illuminate a reflector or reflectarray antenna to form one or more high-gain, electronically steerable spot beams. In example embodiments, the transmit PAFR AESA feed 300 may include an active magneto-electric (ME) dipole array including a plurality of antenna elements, where each antenna element may be coupled to a hybrid circuit generating circular polarization. Each hybrid circuit may be coupled to a tunable filter or band-pass filter and to a solid-state power amplifier (SSPA). In example embodiments, the SSPAs may be configured to amplify broadband military navigation signals prior to radiation. A beamformer may be coupled to the plurality of SSPAs and may control relative amplitude and phase settings across the active ME dipole array to form one or more desired beam patterns. In example embodiments, a digital predistortion module may be coupled to one or more RF paths to linearize the transmit chain and improve spectral performance.

As a nonlimiting example, the PAFR AESA feed 300 may be used to transmit broadband M-code navigation signals toward one or more contested geographic regions, where the beamformer may dynamically adjust phase and amplitude weights to steer multiple beams without mechanical motion of the associated reflector antenna.

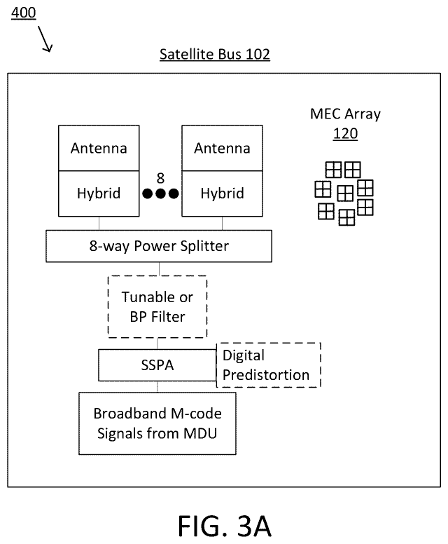

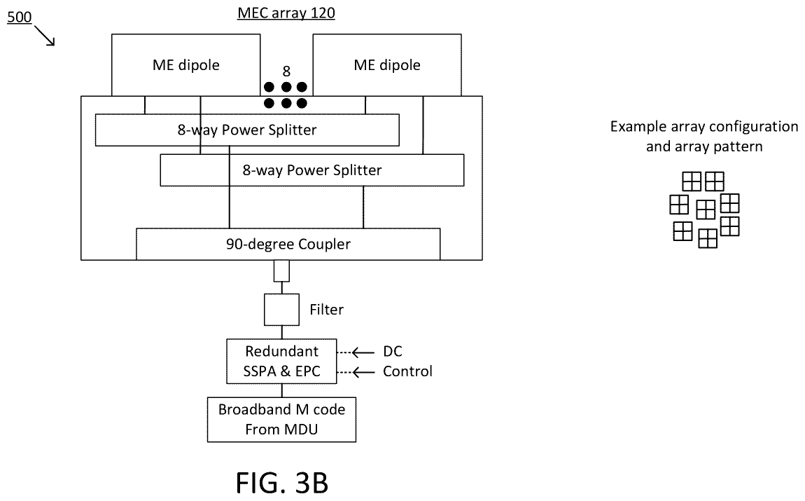

FIG. 3A illustrates example MEC array architectures that may be used with antenna arrays on a satellite navigation payload system 100 in example embodiments. In example embodiments, the feed architectures illustrated in FIG. 3A may be used to support transmission, or transmission and reception, of broadband navigation signals from a satellite bus 102 through an antenna array, such as a Military Earth Coverage (MEC) antenna array 120, while maintaining uniform amplitude and phase control across multiple antenna elements.

FIG. 3A illustrates an MEC array antenna architecture 400. In example embodiments, the transmit-only antenna feed architecture 400 may include a plurality of antenna elements, where each antenna element may be coupled to a hybrid circuit. The 8 antenna elements may be coupled to an 8-way power splitter that may distribute transmit power substantially uniformly across the antenna elements. In example embodiments, broadband M-code signals from a Mission Data Unit (MDU) 210 may be provided to a solid-state power amplifier (SSPA), and the amplified signals may be routed through a tunable filter or band-pass filter prior to distribution by the 8-way power splitter. In example embodiments, a digital predistortion module may be coupled to the SSPA to linearize the transmit chain and improve spectral performance prior to radiation by the antenna elements.

As a nonlimiting example, during on-orbit operation, the antenna architecture 400 illustrated in FIG. 3A may be used to transmit broadband military navigation signals toward the Earth using the MEC antenna array 120, where uniform amplitude and phase distribution across the antenna elements may support consistent coverage over an Earth field of view. In example embodiments, alternative numbers of antenna elements, different power splitter ratios, or different filter configurations may be used while remaining within the scope of the disclosure.

FIG. 3B illustrates an example Military Earth Coverage (MEC) antenna feed and array configuration 500 that may be used with a Military Earth Coverage (MEC) antenna array 120. In example embodiments, the MEC antenna array 120 may be mounted on an Earth deck 104 of a satellite bus 102 and may be configured to radiate broadband military navigation signals toward the Earth and beyond an Earth field of view.

In example embodiments, the MEC antenna array 120 may include a plurality of magneto-electric (ME) dipole antenna elements arranged as an array. The ME dipole antenna elements may be coupled through one or more hybrid circuits and may receive radio-frequency signals distributed by one or more 8-way power splitters. In example embodiments, the use of 8 array elements fed via 8-way power splitters may enable less antenna pattern ripples in azimuth compared to arrays with fewer antenna elements, which may support consistent radiation performance over a wide field of view. In example embodiments, a 90-degree coupler may be coupled to the antenna feed network to generate circular polarization, such as right-hand circular polarization, prior to radiation by the MEC antenna array 120.

In example embodiments, broadband M-code signals from a Mission Data Unit (MDU) 210 may be provided to a redundant solid-state power amplifier and electronic power conditioner (SSPA & EPC) prior to distribution to the antenna elements. A filter may be coupled between the SSPA & EPC and the antenna feed network to suppress out-of-band emissions and improve spectral purity. In example embodiments, one or more digital predistortion modules and direct current (DC) control paths may be coupled to the SSPA & EPC to linearize the transmit chain and manage operating parameters of the MEC antenna array 120.

In example embodiments, the MEC antenna array 120 illustrated in FIG. 3B may be configured to radiate broadband military MEC codes with a radiation pattern optimized for coverage beyond a terrestrial field of view, such as toward a Military Space Service Volume or cislunar region. As a nonlimiting example, during on-orbit operation, the MEC antenna array 120 may transmit broadband M-code navigation signals toward terrestrial users while also providing detectable signal levels to higher-altitude users, where the uniform amplitude and phase distribution across the ME dipole antenna elements may support improved coverage compared to conventional MEC antenna configurations. In example embodiments, other array sizes, element counts, feed network topologies, or polarization schemes may be used to achieve similar functions while remaining within the scope of the disclosure.

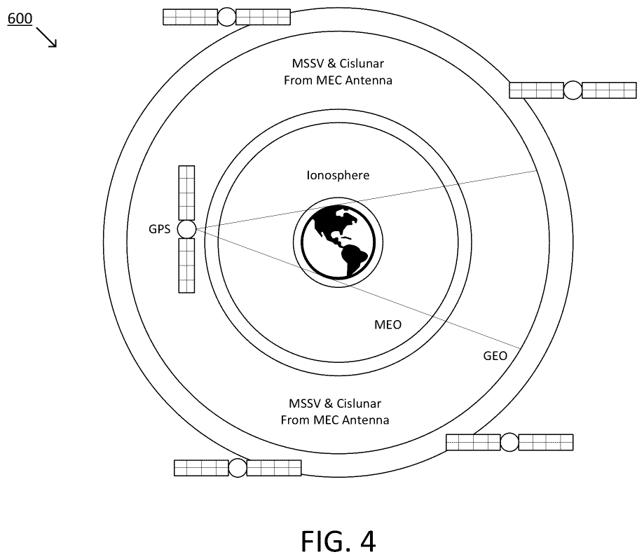

FIG. 4 illustrates an example operational geometry 600 showing how military navigation signals radiated from a Military Earth Coverage (MEC) antenna array 120 may provide coverage beyond an Earth field of view toward higher-altitude regions outside the Earth shadow in example embodiments. In example embodiments, the illustrated geometry may include a Global Positioning System (GPS) satellite operating in a medium Earth orbit (MEO), the Earth and associated ionosphere, and higher-altitude orbital regions including a geosynchronous Earth orbit (GEO) region and a Military Space Service Volume (MSSV) and cislunar region.

In example embodiments, the MEC antenna array 120 may be configured to radiate broadband military navigation signals both toward the Earth and outward beyond the Earth field of view. As illustrated in FIG. 4, signals transmitted from the MEC antenna array 120 may propagate beyond the earth and may remain detectable by receivers located in higher-altitude regions, including the MSSV and cislunar regions. In example embodiments, this radiation behavior may be enabled by antenna element arrangement and amplitude and phase distribution to produce elevated sidelobes outside the nadir-directed Earth coverage region.

In example embodiments, the operational geometry illustrated in FIG. 4 may contrast with conventional GPS satellite payload architectures in which military navigation signals are primarily optimized for Earth-directed coverage. By enabling detectable signal levels beyond the Earth field of view, the MEC antenna array 120 may support positioning, navigation, and timing functionality for space-based users operating at higher altitudes than terrestrial or near-Earth receivers. In example embodiments, such users may include satellites in GEO, highly elliptical orbits, or cislunar trajectories.

As a nonlimiting example, during on-orbit operation, a GPS satellite carrying the MEC antenna array 120 may transmit broadband M-code navigation signals toward the Earth while simultaneously providing detectable signal strength to a space-based receiver operating in the MSSV or along a cislunar transfer trajectory. In example embodiments, such signal availability may support navigation or timing updates for space-based platforms without reliance on Earth-directed relay links. In example embodiments, different orbital altitudes, antenna radiation patterns, or signal bandwidths may be used to achieve similar higher-altitude coverage while remaining within the scope of the disclosure.

In example embodiments, the geometry illustrated in FIG. 4 may represent one of multiple possible operational scenarios, and other example embodiments may include different satellite orbital configurations, different ionospheric conditions, or different receiver locations. The illustrated configuration is provided to show one example of how MEC antenna radiation characteristics may extend military navigation coverage beyond the Earth field of view, while other example embodiments and variations not explicitly illustrated herein may also be used.

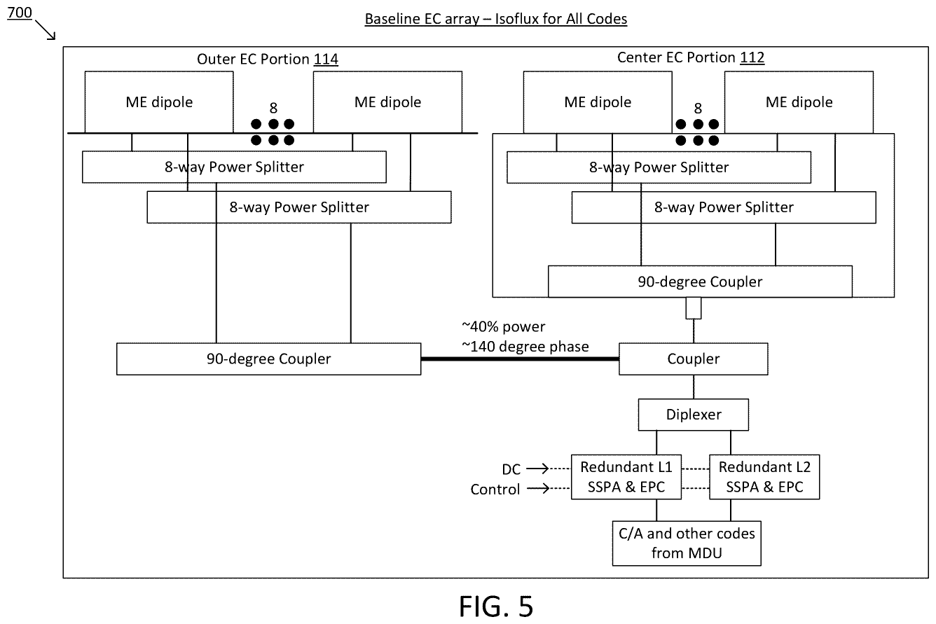

FIG. 5 illustrates a baseline Earth Coverage (EC) antenna array configuration 700 in which an isoflux radiation pattern may be applied to all EC navigation codes. In example embodiments, the baseline EC antenna array configuration 700 may be implemented as the Earth Coverage (EC) antenna array 110 mounted on an Earth deck 104 of a satellite bus 102, and the baseline EC antenna array configuration 700 may be configured to radiate navigation signals uniformly over an Earth field of view to satisfy isoflux coverage requirements.

In example embodiments, the EC antenna array 110 illustrated in FIG. 5 may include a central EC portion 112 and an outer EC portion 114 arranged around the central EC portion 112. The central EC portion 112 and the outer EC portion 114 may each include a plurality of magneto-electric (ME) dipole antenna elements. In example embodiments, radio-frequency signals may be distributed to the ME dipole antenna elements of the central EC portion 112 and the outer EC portion 114 using one or more 8-way power splitters. Each 8-way power splitter feeds either port 1 or two of the 8 ME dipole input ports, while the 90-degree coupler provides the 90-degree phase delay that generates circular polarization from the ME dipole elements.

In example embodiments, navigation signals, including civil coarse acquisition (C/A) codes and other codes, may be provided from a Mission Data Unit (MDU) 210 to a diplexer that may separate frequency bands or code paths. The separated signals may be amplified using redundant L1 and L2 solid-state power amplifiers and electronic power conditioners (SSPA & EPC). In example embodiments, a coupler may be used to divide power between the central EC portion 112 and the outer EC portion 114, such that approximately forty percent of the signal power may be routed to the outer EC portion 114 with an associated phase offset of approximately 140 degrees. One or more 90-degree couplers may be used to generate circular polarization prior to radiation by the ME dipole antenna elements.

In example embodiments, the combined amplitude and phase distribution between the central EC portion 112 and the outer EC portion 114 may cause the EC antenna array 110 to radiate an isoflux pattern for all EC navigation codes. This baseline configuration may provide substantially uniform received signal strength over the Earth field of view, which may be desirable for legacy or backward-compatible navigation services. In example embodiments, filters and digital predistortion modules may be included in the signal path to suppress out-of-band emissions and improve spectral performance.

As a nonlimiting example, during on-orbit operation, the baseline EC antenna array configuration 700 illustrated in FIG. 5 may be used by a GPS satellite to broadcast civil and encrypted navigation signals such that receivers located at different points across the visible Earth surface may observe similar signal power levels. In example embodiments, different numbers of antenna elements, alternative power split ratios, different phase offsets, or different coupler configurations may be used to achieve similar isoflux radiation characteristics, and other example embodiments not explicitly illustrated in FIG. 5 may also be used while remaining within the scope of the disclosure.

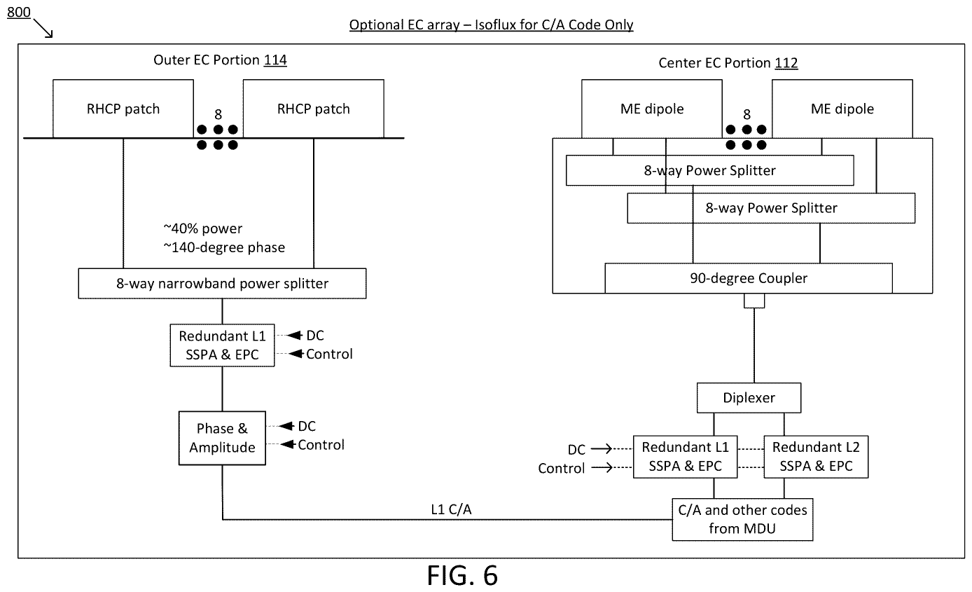

FIG. 6 illustrates an optional Earth Coverage (EC) antenna array configuration 800 in which an isoflux radiation pattern may be applied to a civil coarse acquisition (C/A) code only in example embodiments. In example embodiments, the optional EC antenna array configuration 800 may be mounted on an Earth-facing deck of a satellite bus and may be configured to selectively shape radiation patterns for different navigation signal types transmitted by the EC antenna array 110. Other example embodiments not explicitly illustrated in FIG. 6 may additionally or alternatively be used.

In example embodiments, the EC antenna array 110 illustrated in FIG. 6 may include a center EC portion 112 and an outer EC portion 114 arranged around the center EC portion 112. The center EC portion 112 may be configured to radiate multiple navigation signal types using a non-isoflux radiation pattern, while the outer EC portion 114 may be configured to radiate only a civil C/A code using an isoflux radiation pattern.

In example embodiments, the center EC portion 112 may include a plurality of magneto-electric (ME) dipole antenna elements. The ME dipole antenna elements may be coupled to one or more 8-way power splitters, which may distribute radio-frequency power with substantially uniform amplitude. In example embodiments, one or more 90-degree couplers may be coupled to the 8-way power splitters to generate circular polarization prior to radiation by the ME dipole antenna elements. The center EC portion 112 may receive navigation signals from a Mission Data Unit through a diplexer that may separate civil C/A codes from other navigation codes.

In example embodiments, the outer EC portion 114 may include a plurality of right-hand circularly polarized (RHCP) microstrip patch antenna elements. The microstrip patch antenna elements may be configured to operate at an L1 carrier frequency and to support transmission of a narrowband civil C/A code only. In example embodiments, the use of narrowband microstrip patch antenna elements may allow for reduced component cost and simplified feed networks compared to broadband antenna elements.

In example embodiments, the outer EC portion 114 may be coupled to a narrowband 8-way power splitter that may distribute approximately forty percent of the civil C/A code signal power to the microstrip patch antenna elements. A phase and amplitude control module may be coupled between the narrowband 8-way power splitter and the center EC portion 112, and the phase and amplitude control module may apply an approximately 140-degree phase offset between signals radiated by the outer EC portion 114 and the center EC portion 112. In example embodiments, this controlled power split and phase relationship may cause the combined radiation from the center EC portion 112 and the outer EC portion 114 to form an isoflux radiation pattern for the civil C/A code.

In example embodiments, redundant L1 solid-state power amplifiers and electronic power conditioners (SSPA & EPC) may amplify the civil C/A code prior to distribution to the center EC portion 112 and the outer EC portion 114. Redundant L2 SSPAs and EPCs may amplify other navigation codes that may be radiated by the center EC portion 112 only. Direct current control paths may provide operating power and control signals to the SSPAs, the phase and amplitude control module, and other feed network components.

As a nonlimiting example, during on-orbit operation, a satellite may receive civil C/A code data from a Mission Data Unit, amplify the civil C/A code using a redundant L1 SSPA and EPC, route approximately forty percent of the civil C/A code power to the outer EC portion 114 through the narrowband 8-way power splitter, and apply a controlled phase offset using the phase and amplitude control module. The center EC portion 112 may simultaneously radiate the civil C/A code and other navigation codes using a non-isoflux radiation pattern, while the combined radiation from the center EC portion 112 and the outer EC portion 114 may produce an isoflux radiation pattern for the civil C/A code across an Earth field of view.

In example embodiments, the optional EC antenna array configuration 800 illustrated in FIG. 6 may increase an average radiated EIRP for non-C/A navigation signals over an Earth field of view compared to baseline EC antenna configurations in which all codes are radiated using an isoflux pattern. As a nonlimiting example, during on-orbit operation, a GPS satellite may transmit the civil C/A code using the isoflux radiation pattern to maintain legacy receiver compatibility, while simultaneously transmitting other navigation signals with higher average EIRP toward terrestrial users. In example embodiments, different power split ratios, phase offsets, antenna element counts, or feed network topologies may be used to achieve similar selective isoflux behavior while remaining within the scope of the disclosure.

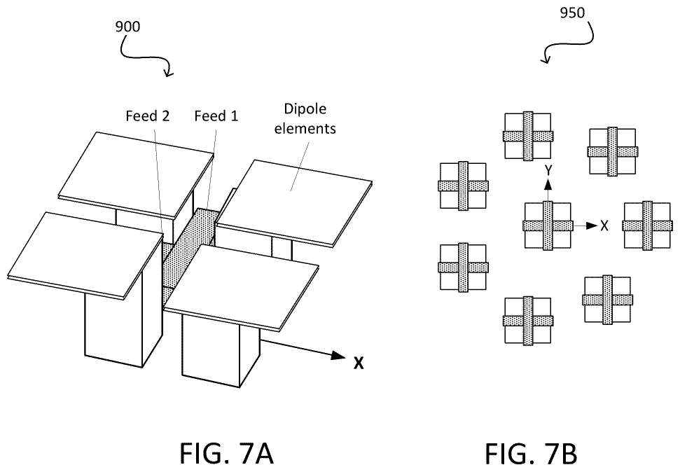

FIGS. 7A and 7B illustrate views 900 and 950 of example magneto-electric (ME) dipole array elements that may be used in antenna arrays of a satellite navigation payload system in example embodiments. In example embodiments, FIG. 7A illustrates a perspective view 900 of an ME dipole array element comprising a plurality of dipole elements arranged in an orthogonal configuration and coupled to a first feed and a second feed. The first feed and the second feed may excite respective orthogonal modes of the dipole elements to support circular polarization. In example embodiments, the dipole elements may be mounted above a ground plane and arranged to provide a low-profile antenna structure suitable for integration into planar or conformal antenna arrays.

In example embodiments, FIG. 7B illustrates a top view 950 of a plurality of ME dipole array elements arranged in a two-dimensional array along orthogonal axes. The arrangement illustrated in FIG. 7B may support array-level beamforming by controlling amplitude and phase excitation of individual ME dipole array elements. In example embodiments, a low-profile ME dipole antenna formed using the ME dipole array elements illustrated in FIGS. 7A and 7B may support broadband signal transmission, such as broadband M-code navigation signal transmission. As a nonlimiting example, the ME dipole array elements may be used in Earth Coverage antenna arrays, Military Earth Coverage antenna arrays, or active feed arrays of phased-array-fed reflector antennas. In example embodiments, other antenna element types may also be used instead of the ME dipole array elements, such as stacked microstrip patch antennas or crossed dipole antennas, while remaining within the scope of the disclosure.

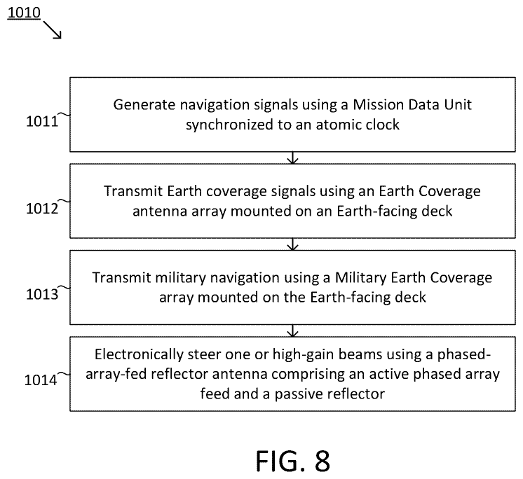

FIG. 8 illustrates a flowchart of a method 1010 for operating a satellite navigation payload system in example embodiments. In example embodiments, the method 1010 may include generating 1011 navigation signals using a Mission Data Unit synchronized to an atomic clock, transmitting 1012 Earth coverage navigation signals using an Earth Coverage antenna array mounted on an Earth-facing deck, transmitting 1013 military navigation signals using a Military Earth Coverage antenna array mounted on the Earth-facing deck, and electronically steering 1014 one or more high-gain beams using a phased-array-fed reflector antenna comprising an active phased array feed and a passive reflector. In example embodiments, the actions illustrated in FIG. 8 may be performed sequentially, concurrently, or in a different order, and one or more actions may be omitted or repeated. As a nonlimiting example, during on-orbit operation, a satellite may generate navigation signals using the Mission Data Unit, broadcast civil navigation signals toward the Earth using the Earth Coverage antenna array, transmit military navigation signals using the Military Earth Coverage antenna array, and electronically steer one or more high-gain beams toward selected geographic regions using the phased-array-fed reflector antenna, while other example embodiments may use different signal types, antenna configurations, or operational sequences while remaining within the scope of the disclosure.

In example embodiments, the satellite navigation payload system described herein may be implemented as a device comprised in a satellite bus. The device may include one or more processors synchronized to an atomic clock and configured to generate navigation signals and control transmission of the navigation signals using an Earth Coverage antenna array, a Military Earth Coverage antenna array, and a phased-array-fed reflector antenna. In example embodiments, the device may control electronic beam steering using an active phased array feed, generate navigation signals including a civil coarse acquisition (C/A) code separately from other navigation codes, and control transmission of broadband military navigation signals. As a nonlimiting example, the device may operate as an integrated navigation payload module mounted within the satellite bus and electrically coupled to the Earth-facing antenna arrays and the Regional Military Protection antenna assembly, while other example embodiments may distribute device functionality across multiple processing units or payload subsystems while remaining within the scope of the disclosure.

Various embodiments may be described in the following clauses:
1. A system comprising:
   a satellite bus with solar panels to generate power for a navigation payload;
   an atomic clock;
   a processor to generate navigation signals synchronized to the atomic clock;
   a Regional Military Protection (RMP) antenna assembly comprising:
      an active phased array feed; and
a passive reflector coupled to the active phased array feed to form a phased-array-fed reflector antenna;
an Earth Coverage (EC) antenna array mounted on an Earth-facing deck of the satellite bus; and
a Military Earth Coverage (MEC) antenna array mounted on the Earth-facing deck of the satellite bus,
wherein the processor is further to transmit navigation signals using the EC antenna array, the MEC antenna array, and the RMP antenna assembly.
2. The system of clause 1, wherein the passive reflector comprises an approximately spherical reflector.
3. The system of clause 1, wherein the passive reflector comprises a passive planar reflectarray.
4. The system of clause 3, wherein the passive planar reflectarray comprises a plurality of printed circuit board panels connected by hinges for deployment from the satellite bus.
5. The system of clause 3, wherein the passive reflector comprises a plurality of radiating antenna elements arranged over a ground plane.
6. The system of clause 1, wherein the passive reflector is coupled to the satellite bus by a support structure comprising a gimbal connected to a stepped motor.
7. The system of clause 1, wherein the RMP antenna assembly and the MEC antenna array are configured to transmit broadband military M-code signals.
8. The system of clause 1, wherein the RMP antenna assembly is configured to electronically steer a plurality of independent high-gain beams without mechanical motion of the passive reflector.
9. The system of clause 1, further comprising at least one of:
   a laser retroreflector array mounted on the Earth-facing deck; or
   an optical crosslink terminal mounted on the satellite bus.
10. A method comprising:
   generating navigation signals synchronized to an atomic clock;
   transmitting Earth coverage navigation signals using an Earth Coverage (EC) antenna array mounted on an Earth-facing deck of a satellite bus;
   transmitting military navigation signals using a Military Earth Coverage (MEC) antenna array mounted on the Earth-facing deck; and
   electronically steering one or more beams using a phased-array-fed reflector antenna comprising an active phased array feed and a passive reflector.
11. The method of clause 10, wherein electronically steering the one or more beams is performed without mechanically moving the passive reflector.
12. The method of clause 10, wherein transmitting military navigation signals comprises transmitting broadband M-code signals.
13. The method of clause 10, wherein generating navigation signals comprises generating a civil coarse acquisition (C/A) code separately from other navigation codes.
14. The method of clause 13, further comprising radiating the civil C/A code using an isoflux radiation pattern while radiating other navigation codes using a non-isoflux radiation pattern.
15. The method of clause 10, further comprising transmitting navigation signals from the MEC antenna array toward at least one of a Military Space Service Volume or a cislunar region.
16. A device comprised in a satellite bus, the device to generate navigation signals using a processor synchronized to an atomic clock, and to transmit the navigation signals using an Earth Coverage (EC) antenna array, a Military Earth Coverage (MEC) antenna array, and a phased-array-fed reflector antenna.
17. The device of clause 16, further to control electronic beam steering using an active phased array feed.
18. The device of clause 16, further to generate a civil coarse acquisition (C/A) code separately from other navigation codes.
19. The device of clause 16, further to transmit broadband military navigation signals.
20. The device of clause 16, further to control transmission of the navigation signals such that a civil coarse acquisition (C/A) code is radiated using an isoflux radiation pattern while one or more other navigation codes are radiated using a non isoflux radiation pattern.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit disclosure to a specific form or forms disclosed, but on the contrary, the intention is to cover all modifications, alternative constructions, and equivalents falling within the spirit and scope of disclosure, as defined in the appended claims.

Use of terms “a” and “an” and “the” and similar referents in the context of describing disclosed embodiments (especially in the context of the following claims) is to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein is merely intended to serve as a shorthand method of referring individually to each separate value falling within range, unless otherwise indicated herein, and each separate value is incorporated into the specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, a set of non-transitory computer-readable storage media comprises multiple non-transitory computer-readable storage media, and one or more of the individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium stores instructions and a main central processing unit (“CPU”) executes some of the instructions while a graphics processing unit (“GPU”) executes other instructions. In at least one embodiment, different components of a computer system have separate processors, and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operations such as addition, subtraction, or multiplication. In at least one embodiment, an arithmetic logic unit is used to implement logical operations such as logical AND/OR or XOR. In at least one embodiment, an arithmetic logic unit is stateless and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to the inputs of the arithmetic logic unit. In at least one embodiment, the instruction codes provided by the processor to the ALU are based at least in part on the instruction executed by the processor. In at least one embodiment, combinational logic in the ALU processes the inputs and produces an output that is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein, and such computer systems are configured with applicable hardware and/or software that enable performance of operations. Further, a computer system that implements at least one embodiment of the present disclosure is a single device and, in another embodiment, is a distributed computer system comprising multiple devices that operate differently, such that the distributed computer system performs operations described herein and such that a single device does not perform all operations.

Use of any and all examples, or exemplary language (e.g., “such as”) provided herein, is intended merely to better illuminate embodiments of disclosure and does not pose a limitation on the scope of disclosure unless otherwise claimed. No language in the specification should be construed as indicating any non-claimed element as essential to the practice of disclosure.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but still cooperate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from a providing entity to an acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an interprocess communication mechanism.

Although descriptions herein set forth example implementations of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
a satellite bus with solar panels to generate power for a navigation payload;
an atomic clock;
a processor to generate navigation signals synchronized to the atomic clock;
a Regional Military Protection (RMP) antenna assembly comprising:
an active phased array feed; and
a passive reflector coupled to the active phased array feed to form a phased-array-fed reflector antenna;
an Earth Coverage (EC) antenna array mounted on an Earth-facing deck of the satellite bus; and
a Military Earth Coverage (MEC) antenna array mounted on the Earth-facing deck of the satellite bus,
wherein the processor is further to transmit navigation signals using the EC antenna array, the MEC antenna array, and the RMP antenna assembly.

2. The system of claim 1, wherein the passive reflector comprises an approximately spherical reflector.

3. The system of claim 1, wherein the passive reflector comprises a passive planar reflectarray.

4. The system of claim 3, wherein the passive planar reflectarray comprises a plurality of printed circuit board panels connected by hinges for deployment from the satellite bus.

5. The system of claim 3, wherein the passive reflector comprises a plurality of radiating antenna elements arranged over a ground plane.

6. The system of claim 1, wherein the passive reflector is coupled to the satellite bus by a support structure comprising a gimbal connected to a stepped motor.

7. The system of claim 1, wherein the RMP antenna assembly and the MEC antenna array are configured to transmit broadband military M-code signals.

8. The system of claim 1, wherein the RMP antenna assembly is configured to electronically steer a plurality of independent high-gain beams without mechanical motion of the passive reflector.

9. The system of claim 1, further comprising at least one of:
a laser retroreflector array mounted on the Earth-facing deck; or
an optical crosslink terminal mounted on the satellite bus.

10. A method comprising:
generating navigation signals synchronized to an atomic clock;
transmitting Earth coverage navigation signals using an Earth Coverage (EC) antenna array mounted on an Earth-facing deck of a satellite bus;
transmitting military navigation signals using a Military Earth Coverage (MEC) antenna array mounted on the Earth-facing deck; and
electronically steering one or more beams using a phased-array-fed reflector antenna comprising an active phased array feed and a passive reflector.

11. The method of claim 10, wherein electronically steering the one or more beams is performed without mechanically moving the passive reflector.

12. The method of claim 10, wherein transmitting military navigation signals comprises transmitting broadband M-code signals.

13. The method of claim 10, wherein generating navigation signals comprises generating a civil coarse acquisition (C/A) code separately from other navigation codes.

14. The method of claim 13, further comprising radiating the civil C/A code using an isoflux radiation pattern while radiating other navigation codes using a non-isoflux radiation pattern.

15. The method of claim 10, further comprising transmitting navigation signals from the MEC antenna array toward at least one of a Military Space Service Volume or a cislunar region.

16. A device comprised in a satellite bus, the device to generate navigation signals using a processor synchronized to an atomic clock, and to transmit the navigation signals using an Earth Coverage (EC) antenna array, a Military Earth Coverage (MEC) antenna array, and a phased-array-fed reflector antenna.

17. The device of claim 16, further to control electronic beam steering using an active phased array feed.

18. The device of claim 16, further to generate a civil coarse acquisition (C/A) code separately from other navigation codes.

19. The device of claim 16, further to transmit broadband military navigation signals.

20. The device of claim 16, further to control transmission of the navigation signals such that a civil coarse acquisition (C/A) code is radiated using an isoflux radiation pattern while one or more other navigation codes are radiated using a non-isoflux radiation pattern.
